(19) United States
(12) Patent Application Publication
(10) Pub. No.: US 2013/0178294 A1
(43) Pub. Date: Jul. 11, 2013

(54) CONTROL SYSTEM AND METHOD OF MULTIPLE MANIPULATING INPUTS AND MUSIC OUTPUTS OF WIRELESS GAMING DEVICE

(71) Applicant: Kun Shan University, Tainan City (TW)

(72) Inventors: PING-TSUNG WANG, TAINAN CITY (TW); HAN-CHIANG CHEN, TAINAN CITY (TW); SHU-YI SYU, TAINAN CITY (TW)

(73) Assignee: KUN SHAN UNIVERSITY, TAINAN CITY (TW)

(21) Appl. No.: 13/672,888

(22) Filed: Nov. 9, 2012

(30) Foreign Application Priority Data
Nov. 15, 2011 (TW) 100141717

(51) Int. Cl. A63F 13/02; A63F 13/06

(52) U.S. Cl. CPC A63F 13/02; A63F 13/06
USPC 463/38; 463/37

(57) ABSTRACT

A control system for multiple manipulating inputs and music outputs of wireless gaming device is provided, in which multiple wireless gaming devices can be collected in one-to-multiple manner, and the manipulating signals input from multiple wireless gaming devices can manipulate the game on the game console by a single wireless dongle under the same wireless frequency with interactive communication framework, and the game music can be transmitted to the audio interface of each of the wireless gaming devices and is played uninterruptedly, so as to possess both functions of using wireless gaming devices to manipulate game console and of transmitting game music outputted from the audio output interfaces of the wireless gaming devices to the audio output devices such as speakers or headsets.

### BACKGROUND OF THE INVENTION

1. Field of the Invention

The present invention relates to a control system and method of multiple manipulating inputs and music outputs of wireless gaming device, more particularly to a control system and method of multiple manipulating inputs and music outputs of wireless gaming device in which the manipulating signals input from multiple wireless gaming devices can manipulate smoothly the game on the game console by a single wireless dongle, under the same wireless frequency, and the game music can be transmitted to the audio interface of each of the wireless gaming devices and is played uninterruptedly.

2. Brief Description of Prior Art

Current technology available on market to be applied in manipulating the execution state of wireless gaming is to adopt a wireless dongle mounted on a gaming console and a single game manipulator for conducting reception and transmission of manipulating signals, i.e., each game manipulator can only combine with a wireless dongle to input the manipulating signals from the game manipulator to the game console so as to perform the game play. When multiple game manipulators are used to play contest game simultaneously, wireless dongles having quantities equivalent to the number of game manipulators have to be connected to the game console, and each of the game manipulators corresponds to one wireless dongle. Thus, manipulating signals outputted from each game manipulator is transmitted wirelessly to corresponding wireless dongle and then to the game console, so that the game console begins to perform each aspect of a game according to the manipulating signals.

When two users want to conduct game play on a game console, two wireless joysticks have to be combined separately with two wireless dongles inserted in the game console, according to the current technology. However, game music came from the game console can not be received and output from an audio output device (such as headset) of the two joysticks simultaneously. In the case of fearing not to annoy other people, volume of the game console's speaker is adjusted to be small, and thus the sound matching effect is decreased and this will reduce both the feeling and fun of gaming. That is to say, conventional joystick only possesses the function of inputting to the game console, without the function of collecting. So, additional one wireless dongle has to be used with one wireless headset. Thus, four wireless dongles have to be adopted in order that two users wearing headsets can conduct game play with two separate joysticks.

Referring to a Taiwanese Patent Application No. 200703955 entitled “One-way Multiple-channel Communication System and Method of Multiple Wireless Input Devices”, the system can be communicated with each of the multiple input devices with variable different channel under one-way communication framework. When user changes the input signal channel of an input device, the user starts the receiver into learning mode and starts the input device to transmit its ID code and channel data after switching through a common channel. The receiver can receive input signals according to updated channel data.

However, the above technology is to distinguish between the input signals of each of the input devices through different channel and with the help of ID code. This technology is more complicated and cumbersome, and did not consider the problems of outputting the music signals to the user's wireless device.

Nowadays, the present invention can realize the usage of a single wireless dongle to collect wireless gaming devices of multiple players, and to transmit game music to an audio output interface of each of the wireless gaming devices for playing.

### SUMMARY OF INVENTION

The main object of the present invention is to provide a control system and method for multiple manipulating inputs and music outputs of wireless gaming device, in which multiple wireless gaming devices can be collected in one-to-multiple manner, and the manipulating signals input from multiple wireless gaming devices can manipulate the game on the game console by a single wireless dongle under the same wireless frequency with interactive communication framework, and the game music can be transmitted to the audio interface of each of the wireless gaming devices and is played uninterruptedly, so as to possess both functions of using wireless gaming devices to manipulate game console and of transmitting game music outputted from the audio output interfaces of the wireless gaming devices to the audio output devices such as speakers or headsets.

This invention relates to a control system for multiple manipulating inputs and music outputs of wireless gaming device, comprising a wireless dongle and multiple gaming devices. The dongle is inserted in the game console end, which enables collection of wireless gaming devices (such as joysticks, gamepads, steering wheels of race car) of multiple players, and which enables game music to be outputted to audio output interfaces of individual wireless gaming devices for multiple users and to be played by the audio output devices (such as speakers or headsets).

The framework of the wireless dongle comprises a game console end interface, a data in/out queue, and a radio frequency (RF) transmission interface of wireless dongle (RF interface of wireless dongle), wherein the game console end interface (host interface) is connected to the game console; the data in/out queue having an input queue and an output queue respectively therein, the input queue being for storing input manipulating signals of multiple players received by the RF interface of wireless dongle, while the output queue being for storing the music signals outputted from the game console; the RF interface of wireless dongle being the interface for conducting wireless data transmission with multiple wireless gaming devices.

Each of the wireless gaming devices comprises a RF interface of wireless gaming device, a packet processing module, a keyboard unit and an audio output interface. The keyboard unit is an element for players to manipulating each game control. The packet processing module has a keyboard command packet queue and a music queue therein, in which the keyboard command packet queue is for storing the input data of controlling game by operating said keyboard unit at player end, and the music queue is for storing the music signals came from the game console. The RF interface of the wireless gaming device is an interface for conducting wireless data transmission with the wireless dongle, by which the data in the keyboard command packet queue can be transmitted to the wireless dongle, and by which the music signals at the game console emitted by the wireless dongle can be received. The audio output interface is for outputting the music signals from the music queue to the audio output device, where the music signals is then played.

This invention also relates to a control method for multiple manipulating inputs and music outputs of wireless gaming devices, each of the multiple wireless gaming devices comprising a RF interface of wireless gaming device. A wireless dongle is mounted on the game console, which includes a RF interface of wireless dongle for transmitting manipulating signals came from the game console to each of the wireless gaming devices. The wireless dongle and the multiple wireless gaming devices adopt the same wireless frequency.

The process of transmitting manipulating signals came from each of the wireless gaming devices to the game console comprises the steps as described below.
(A) set a music period t and a music signals packet is generated in each music period t, and ID value for obtaining desired wireless gaming device is attached in the music signals packet;
(B) ID value of each wireless gaming device is set by the wireless dongle, and the range of the ID value is between 0 and the quantity of the wireless gaming device (m)−1;
(C) When each music period t arrives, the wireless dongle immediately sends music signals packet attached with ID value of desired wireless gaming device regularly to all wireless gaming devices, the period of attaching the ID value, corresponding to each of the wireless gaming devices, to the packet sent by the wireless dongle is T;
(D) All the wireless gaming devices receive the packet sent in step (C), and the wireless gaming device having its ID value conforming to the ID value in the packet makes a reply to the wireless dongle with a game command packet;
(E) Once the wireless dongle receives the packet of step (D), a reply to the game console with the game command of the associated device is conducted; next, a new ID value is generated by adding 1 to the ID value and the new ID value is attached to the music signals packet; and steps (C), (D), (E) are repeated so that the wireless dongle can output manipulating signals to the game console sequentially;
(F) When the HID period to the first wireless gaming device calculated by the wireless dongle arrives, the ID value is automatically set to ground zero and process is restarted from step (C).

### BRIEF DESCRIPTION OF THE DRAWINGS

FIG. 1 is a schematic view showing the outline framework of the control system of multiple manipulating inputs and music outputs of wireless gaming device of the present invention.

FIG. 2 is a schematic view showing the internal framework of the control system of multiple manipulating inputs and music outputs of wireless gaming device of the present invention.

FIGS. 3(A) and 3(B) are continuous flow charts showing the control method of multiple manipulating inputs and music outputs of wireless dongle of the present invention.

FIG. 4 is a flow chart showing the control method of multiple manipulating inputs and music outputs of wireless gaming device of the present invention.

FIG. 5 is a schematic view showing the transmission timing of the music signals packet and the game manipulating signals packet in the wireless dongle and the wireless gaming device in one-to-one arrangement of the present invention.

FIG. 6 is a schematic view showing the transmission timing of the music signals packet and the game manipulating signals packet in the wireless dongle and the wireless gaming device in one-to-three arrangement of the present invention.

FIG. 7 is a schematic view showing the transmission timing of the music signals packet and the game manipulating signals packet in the wireless dongle and the wireless gaming device in one-to-multiple arrangement of the present invention.

FIG. 8 is a view showing the interrelationship of the periods of transmitting game manipulating packet and music signals packet.

### DETAILED DESCRIPTION OF PREFERRED EMBODIMENT

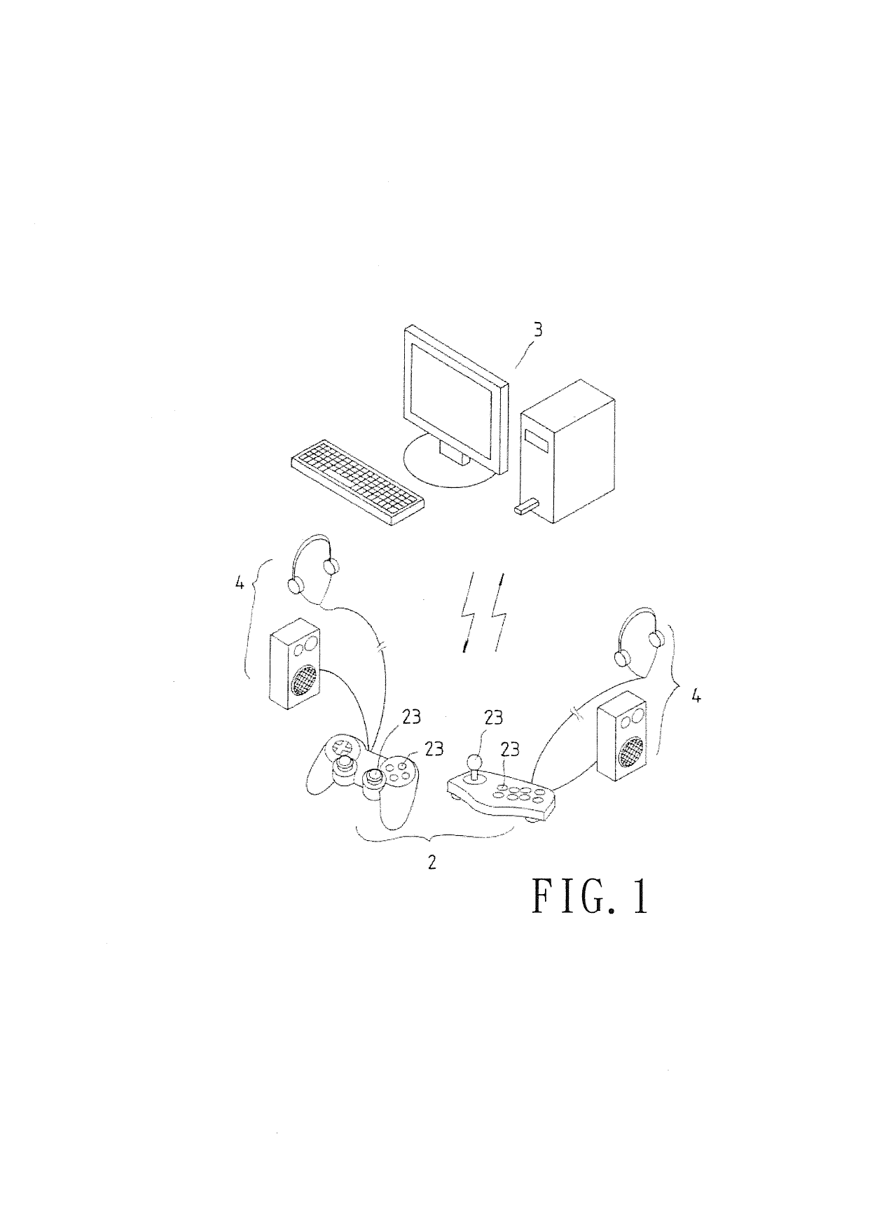

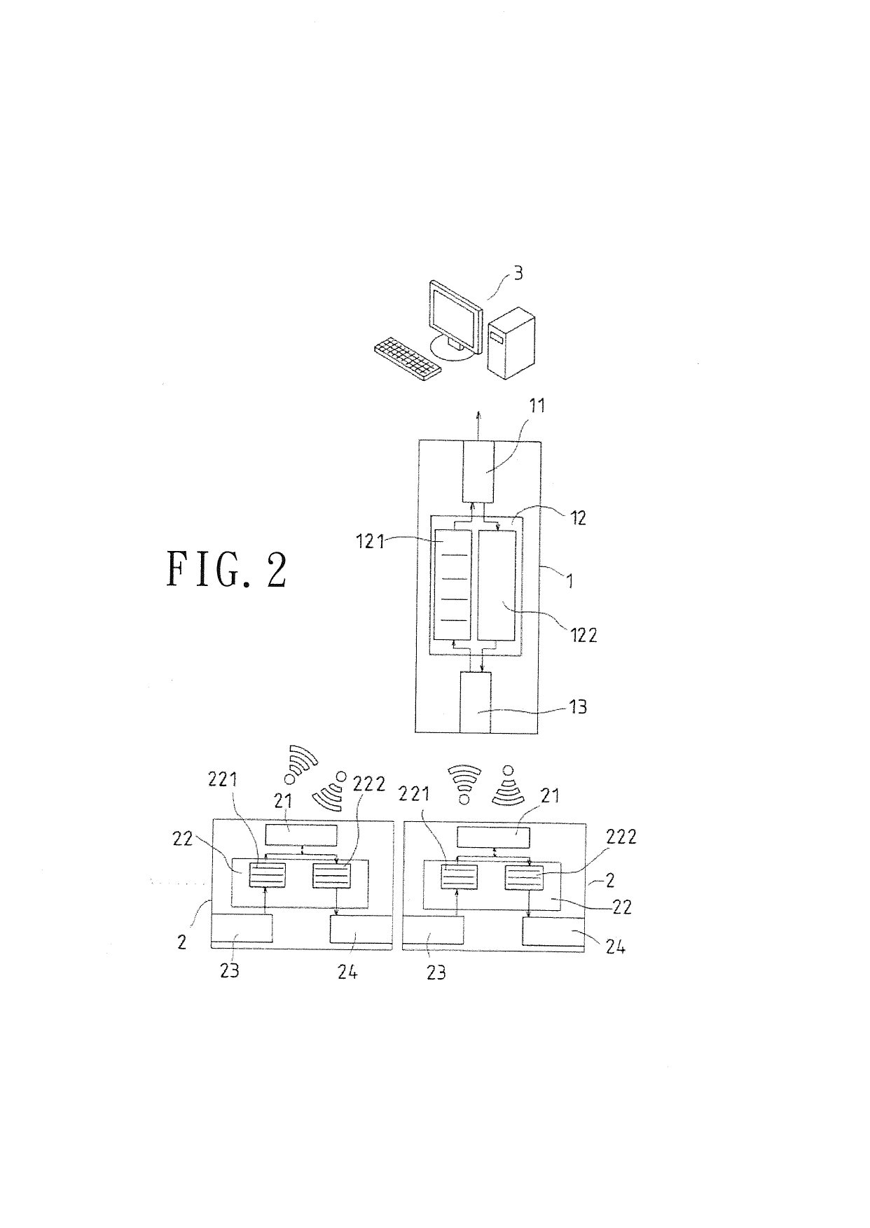

Referring to FIGS. 1 and 2, the control system for multiple manipulating inputs and music outputs of wireless gaming devices of the present invention comprises a wireless dongle 1 and multiple gaming devices 2. The wireless dongle 1 is inserted in the game console end 3, which enables the collection of manipulating signals transmitted by the wireless gaming devices 2 (such as joysticks, gamepads, steering wheels of race car) of multiple players, and simultaneously enables game music to be outputted to audio output interfaces of individual wireless gaming devices 2 for multiple players.

The framework of the wireless dongle 1 comprises a game console end interface (host interface) 11, a data in/out queue 12, and a radio frequency (RF) transmission interface of wireless dongle (RF interface of wireless dongle) 13, wherein the host interface 11 is, in a general sense, an interface such as USB, 1394, PCI-e, PS/2, SATA, Ethernet, SPI, and UART which is connected to the game console. The data in/out queue 12 has an input queue 121 and an output queue 122 respectively therein, in which the input queue 121 is used for storing input manipulating signals of multiple players received by the RF interface of wireless dongle 13, while the output queue 122 for storing the music signals outputted from the game console 3 so as to prepare to transmit the music signals to each of the wireless gaming devices of multiple players through the RF interface of wireless dongle 13. The RF interface of wireless dongle 13 is the interface for conducting wireless data transmission with the multiple wireless gaming devices 2, the frequency band used in the RF interface of wireless dongle 13 being 2.4 GHz ISM Band or the other wireless frequency.

Each of the wireless gaming devices 2 is for users to manipulating various controls of game, such as a gamepad, a joystick, a steering wheel of race car or a 3D joystick (Wii). Each of the wireless gaming devices 2 comprises a RF interface of wireless gaming device 21, a packet processing module 22, a keyboard unit 23, and an audio output interface (audio out) 24. The RF interface of wireless gaming device 21 is an interface for conducting wireless data transmission with the wireless dongle 1, the frequency band used therein is 2.4 GHzISM Band or the other wireless frequency. The keyboard unit 23, in a general sense, is an element for users to manipulate various control of a game. The packet processing module 22 has a keyboard command packet queue 221 and a music queue 222 respectively therein. The keyboard command packet queue 221 is used for storing various game control command packet data generated by operating the keyboard unit 23 on the wireless gaming device 2 at the player end, while the music queue 222 is used for storing music signals transmitted from the wireless dongle 1 at the game console end 3. The audio output interface 24 is for outputting music signals from the music queue 222 to an audio output device 4 where the music signals is played. The audio output device 4 can be a speaker or a headset.

The game console end 3 is one of the game host machine constructed from desktop computer, notebook computer, tablet, game machine, set top box, handphone and embedded systems.

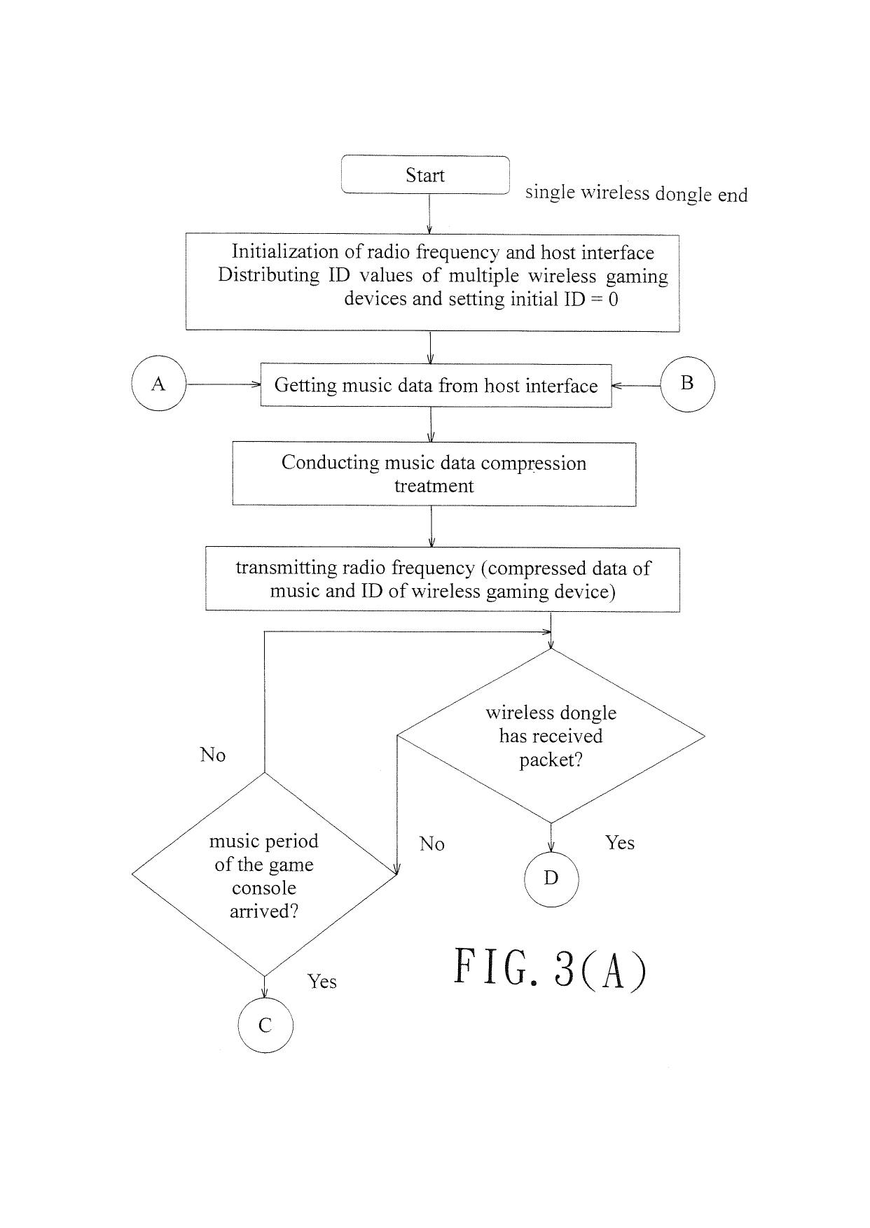

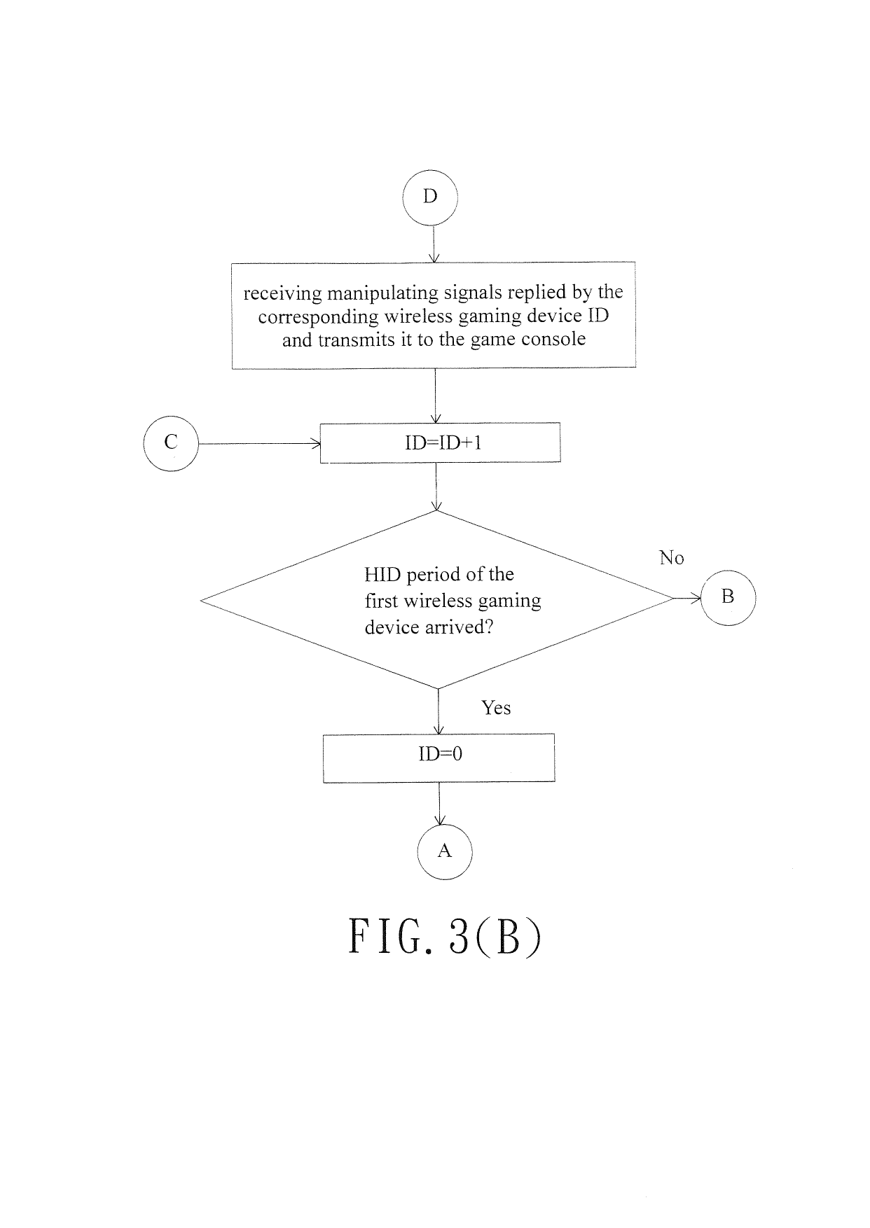

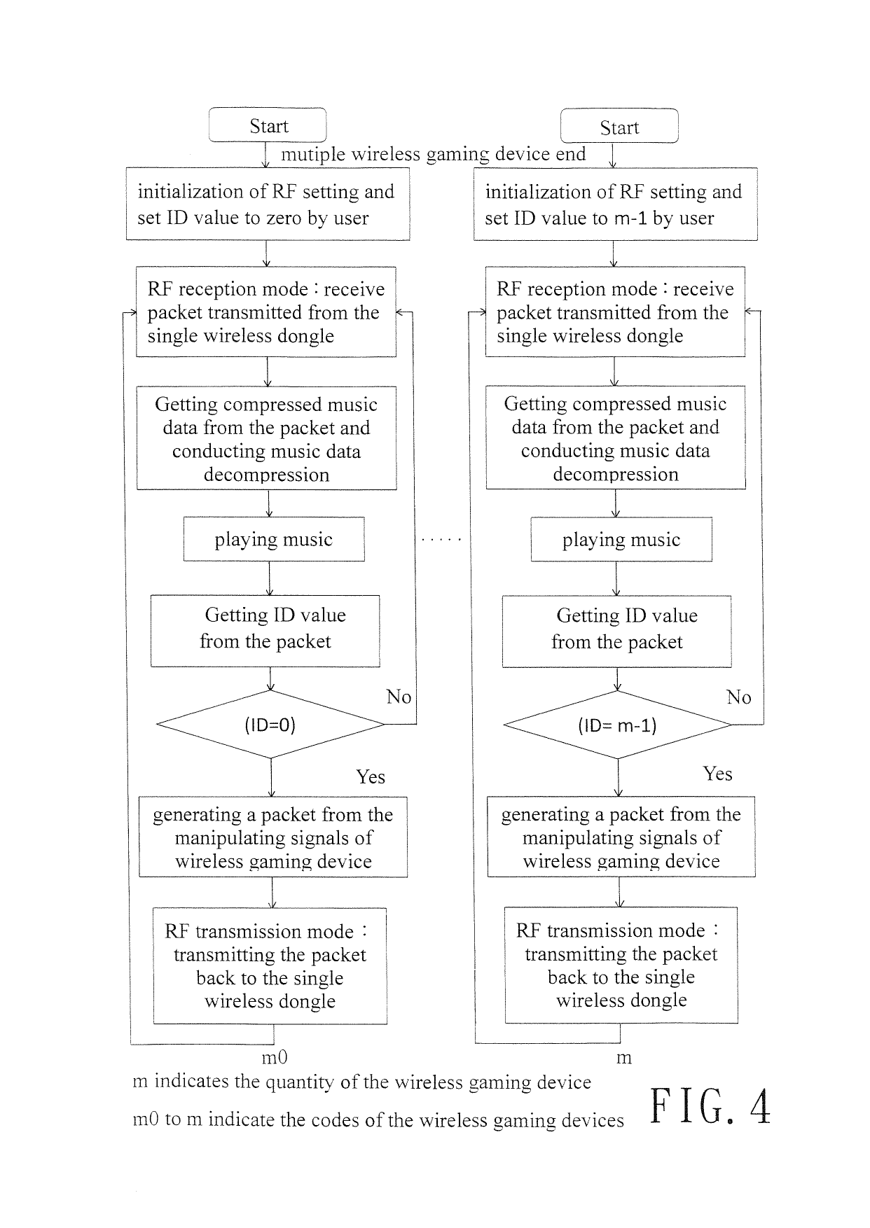

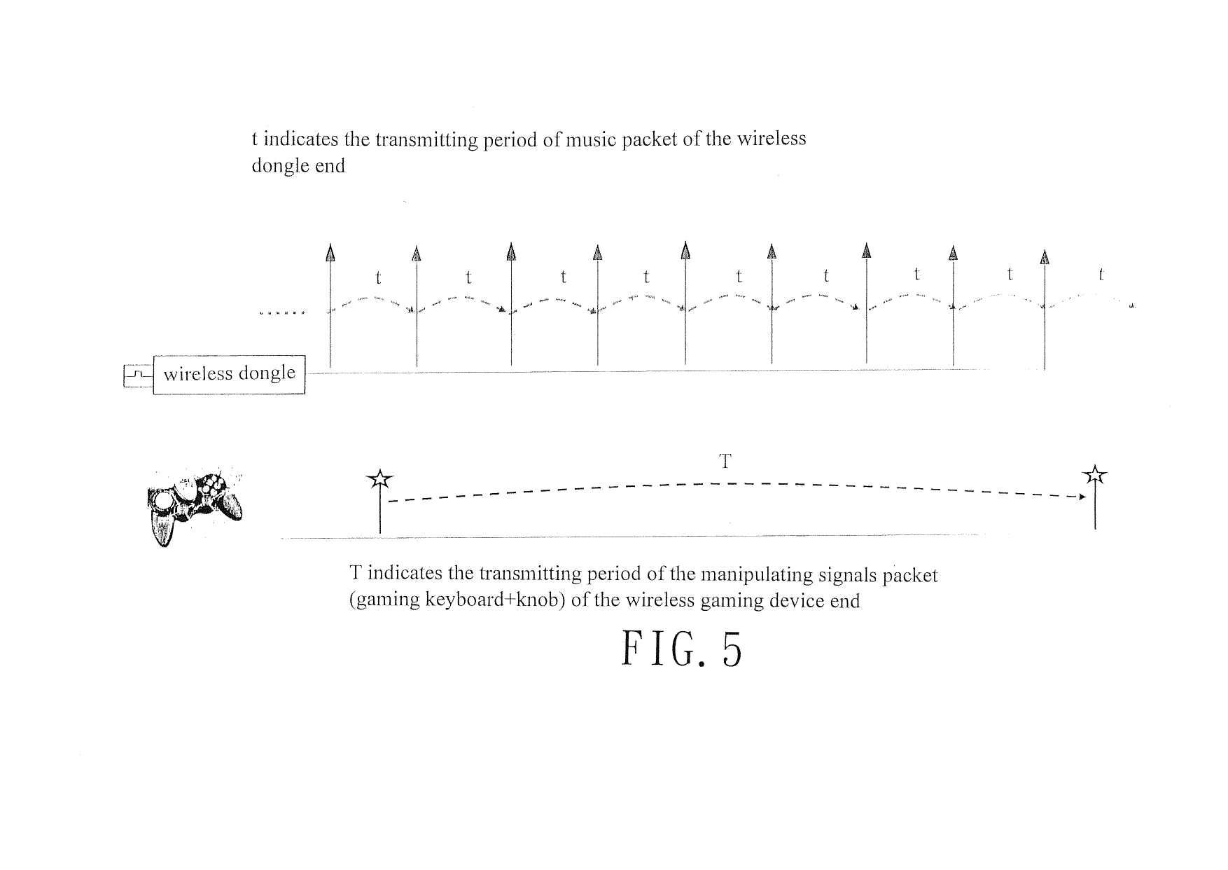

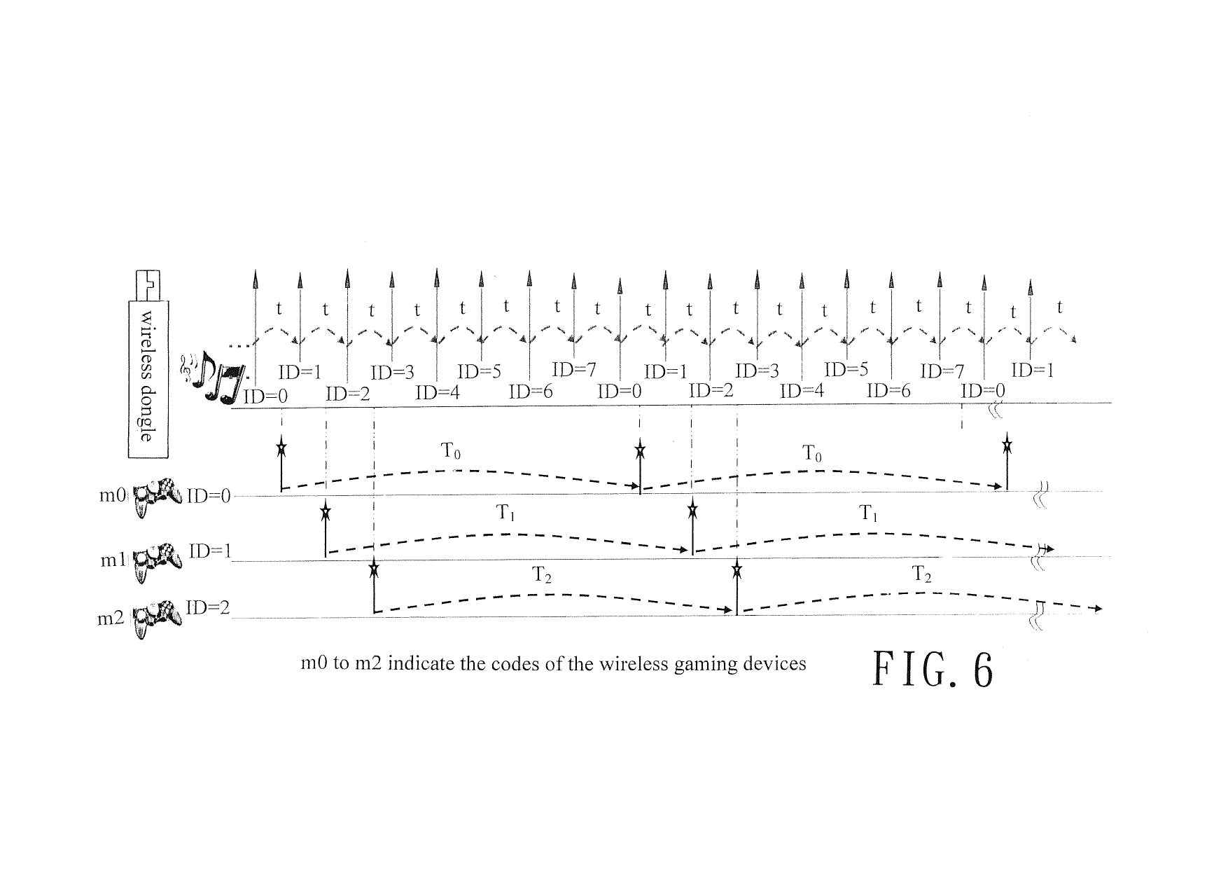

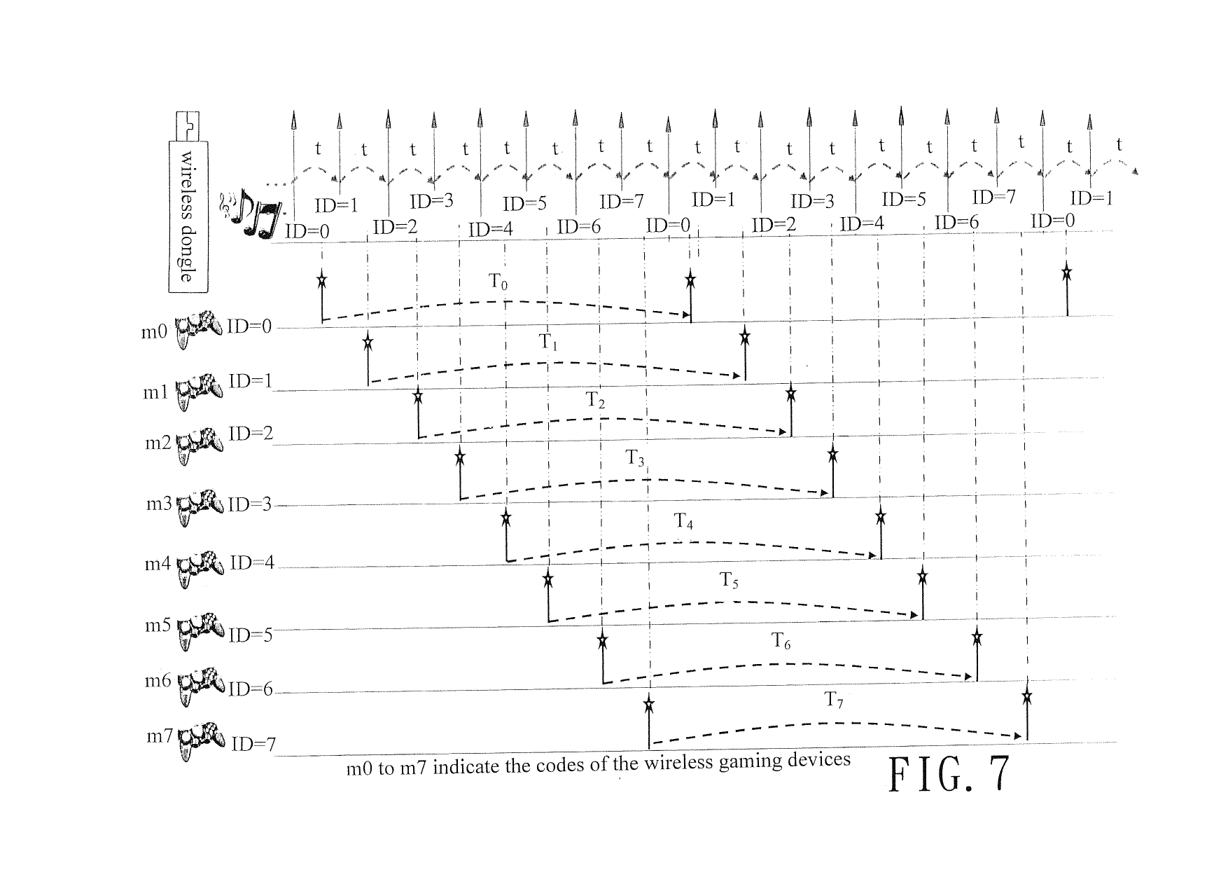

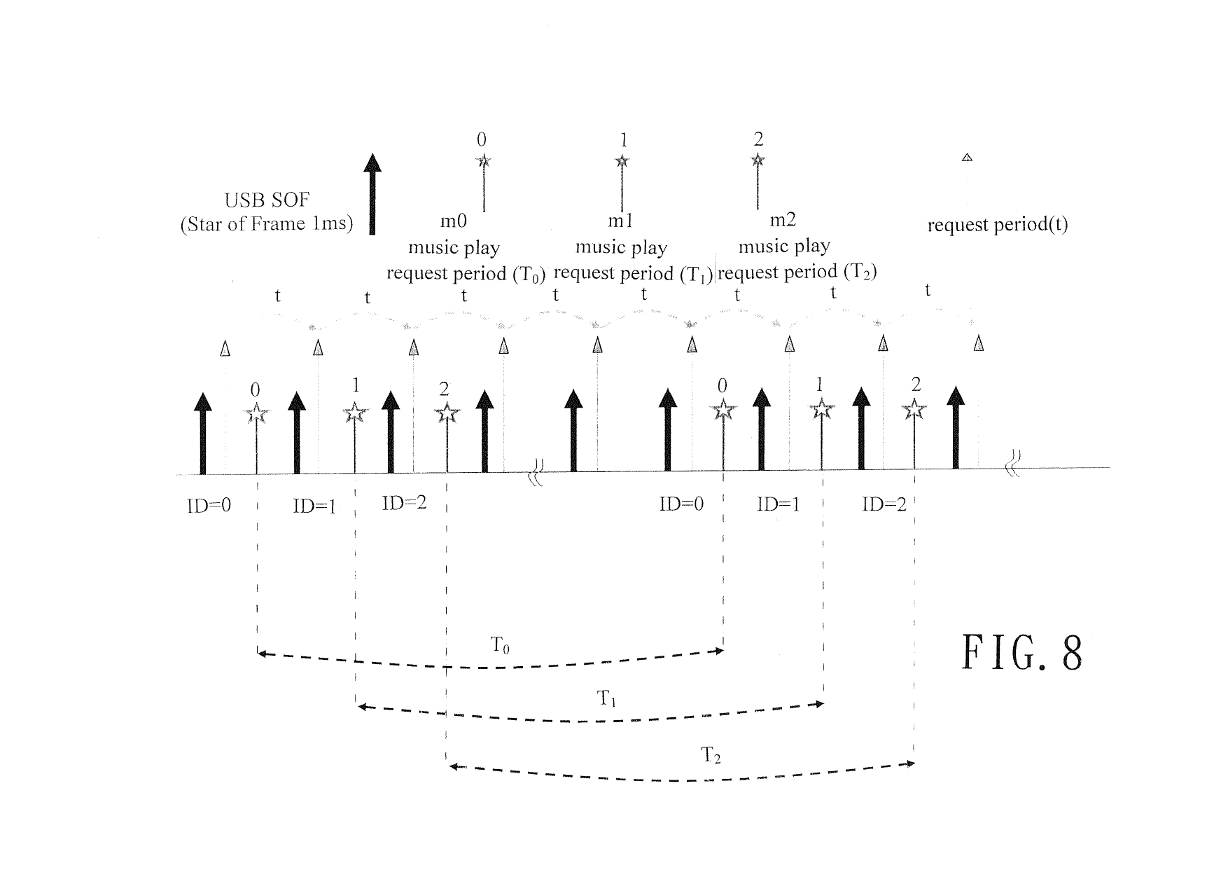

The control method for multiple manipulating inputs and music outputs of wireless gaming devices of the present invention, referring to FIGS. 3 to 8, is to arrange multiple wireless gaming devices 2 at player end and a wireless dongle 1 at the end of the wireless gaming device 2. Through the coordinated operation between the wireless dongle 1 and each of the wireless gaming devices 2, the wireless dongle 1 and the multiple wireless gaming devices 2 enable the manipulating signals came from each of the wireless gaming devices 2, under the same wireless frequency, to be transmitted sequentially from the wireless dongle 1 to the game console end 3, and the music signals came from the game console end 3 to be transmitted to each of the wireless gaming devices 2 at the player end.

Further, this invention can set 1P Player, 2P Player, 3P Player, . . . nP Player corresponding to each of the wireless gaming devices itself. Therefore, when there is only one wireless gaming device 2, the wireless dongle 1 conducts operation with the wireless gaming device 2 in one-to-one mode. When there are 2 or more wireless gaming devices 2, the wireless dongle 1 conducts operation with the wireless gaming devices 2 in one-to-multiple mode. If the wireless band in current operation encounters interference during the process of gaming or music playing, frequency-hopping can be conducted automatically or manually, i.e., a frequency-hopping push button or an assembly button on the wireless gaming device is pushed, then the wireless gaming device 1 together with the wireless dongle 1 and the other wireless gaming devices 2 can change wireless operating frequency.

In detailed explanation, the abovementioned method of the present invention comprises the following steps.
(A) set a music period t and a music signals packet is generated in each music period t, and ID value for obtaining desired wireless gaming device 2 is attached in the music signals packet;
(B) ID value of each wireless gaming device 2 is set by the wireless dongle 1, and the range of the ID value is between 0 and the quantity of the wireless gaming device (m)−1;
(C) When each music period t arrives, the wireless dongle 1 immediately sends music signals packet attached with ID value of desired wireless gaming device 2 regularly to all wireless gaming devices 2, the period of attaching the ID value, corresponding to each of the wireless gaming devices 2, to the packet sent by the wireless dongle, i.e., the transmission period of the game manipulating signals packet is T;
(D) All the wireless gaming devices can receive the packet sent in step (C) and decompress the music signals to play, and the wireless gaming device 2 having its ID value conforming to the ID value in the packet makes a reply to the wireless dongle 1 with a game command signals packet;
(E) Once the wireless dongle 1 receives the packet of step (D), a reply to the game console end 3 with the game command of the associated wireless gaming device 2 is conducted; next, a new ID value is generated by adding 1 to the ID value and the new ID value is attached to the music signals packet; and steps (C), (D), (E) are repeated so that the wireless dongle 1 can output manipulating signals to the game console end sequentially;
(F) When the HID period to the first wireless gaming device 2 calculated by the wireless dongle 1 arrives, the ID value is automatically set to ground zero and process is returned to step (C).

When conducted in the manner according to above steps, the wireless dongle 1 and the multiple wireless gaming device 2, operating under the same wireless frequency, enable the transmission of both the music signals and the game manipulating signals. The term “operating under the same wireless frequency” means when the wireless dongle 1 emits music signals packet attached with ID value, only the wireless dongle 1 is emitting music signals packet while the other multiple wireless gaming devices 1 are receiving the music signals packet. When certain wireless gaming device 2 receives music signals packet having attached ID value conforming to that of itself, this wireless gaming device 2 emits game manipulating signals packet with itself attached therewith to the wireless dongle 1, and the other wireless gaming devices 2 and the wireless dongle 1 are all in receiving state. Therefore, all the wireless gaming devices 2 and the wireless dongle 1 will not have the situation of emitting packet conflicting with each other, so that they can operated under the same frequency, i.e., there is always only one device is in the state of emitting and the other devices are in the state of receiving at the same time. Therefore, there is no such condition that 2 or more devices are emitting wireless packet at the same time.

Furthermore, the multiple wireless gaming devices 2 can be manipulated by one or multiple players simultaneously and data is collected to the wireless dongle 1 inserted in the game console end 3, and the one or multiple wireless gaming devices 2 simultaneously receive the music signals transmitted from the wireless dongle 1 so that each of the multiple wireless gaming devices 2 can drive the audio output device 4 connected therewith to play the music. At the same time, the music signals emitted from the wireless dongle 1 is attached with ID. When the ID value is conformed to that of a certain wireless gaming device 2, this wireless gaming device 2 will be selected and its manipulating signals will be sent to the wireless dongle 1 and then transmitted to the game console end 3 through the host interface 11 to conduct manipulation of gaming mode, so that the progressing mode of the game can be smoothly manipulated without any interference occurred between one another among the manipulating signals inputted from the multiple wireless gaming devices 2 and the game music can also be transmitted smoothly to the audio output devices 4 connected to or built-in in each of the wireless gaming devices 2 for playing uninterruptedly.

In other words, when one or multiple users perform the game within the game console and use multiple wireless gaming devices 2, the manipulating signals generated by users controlling the keyboard unit 23 of each of the wireless gaming devices 2 are stored in the keyboard command packet queue 221 in the packet processing module 22. when the wireless dongle 1 receives the music signals came from the game console end 3, the music signals are stored in the output queue 122 within the data in/out queue 12 of the wireless dongle 1 so as to generate a music signals packet incorporated with an ID therewith, and to wait for the transmission of the music signals packet during each music period t by the RF interface 13 of the wireless dongle 1. After the RF interface 21 of each of the wireless gaming devices 2 receives the music signals packet transmitted during each music period t from the wireless dongle 1, each of the wireless gaming devices 2 stores the music signals packet in the music queue 222 within the packet processing module 22, and the music signals inside the music signals packet is decompressed and then outputted to the audio output device 4, such as a speaker or a headset, connected to associated wireless gaming device 2 for music playing. Each of the wireless gaming devices 2 receives the music signals packet and thus obtains the ID attached therewith. When the ID value is conformed to the ID already set in the wireless gaming device 2 itself, the wireless gaming device 2 is selected. At this moment, the manipulating signals packet of the selected wireless gaming device 2 stored in the keyboard command packet queue 221 within the packet processing module 22 is transmitted out by the RF interface 21 of the wireless gaming device 2, and is received by the RF interface 13 of the wireless dongle 1 so that the game manipulating signals packet is stored in the input queue 121 within the data in/out queue 12 of the selected wireless gaming device 2, and the manipulating signals in each game manipulating signals packet is transmitted, according to its storage sequence, by the host interface 11 to the game console end 3 for performing the gaming control.

Moreover, the method of the present invention further comprises a D1 step subsequent to the step (C). In D1 step, whether the wireless dangle 1 has received game manipulating signals packet transmitted from the wireless gaming device 2 or not is further judged during a music period t. If the wireless dongle 1 hasn't received game manipulating signals packet transmitted from the wireless gaming device 2 until the end of the music period t, the wireless dongle 1 is enforced to depart from RF reception state and the ID value is forced to add with 1, and the process is returned to step (C). In this manner, when the total quantities of the wireless gaming devices 2 do not satisfy the number of the music signals packet within the transmission period T of the game manipulating signals packet, each of the wireless gaming devices 2 can transmits the game manipulating signals packet to the wireless dongle 1 smoothly until the end of the transmission period T of the affiliated game manipulating signals packet.

Based on the foregoing, the technical content of the present invention can allow one or more players to play game on the same game console simultaneously with wireless game joysticks, gamepads, or steering wheels of race car or 3D joysticks different from each other, and with only one wireless dongle inserted in the game console. Especially, each player can simultaneously receive game music came from the game console end. In other words, this invention can achieve the function of having simultaneous wireless input and wireless output, and the function of collecting manipulating game data of multiple wireless gaming devices to a single game console end. That is to say, the quantity of wireless dongle can be reduced, and the multiple wireless gaming devices can receive simultaneously the game music came from the wireless dongle, so that the defect of failing to receive wireless music found on the conventional wireless joystick available on the market can be really improved.

What is claimed is:

1. A control system for multiple manipulating inputs and music outputs of wireless gaming device, comprising:
a wireless dongle inserted in a game console end, which includes a host interface, a data in/out queue, and a RF interface of wireless dangle, said host interface being connected to said game console end; said data in/out queue having an input queue and an output queue respectively therein, said input queue being for storing input manipulating signals of multiple players received by said RF interface of wireless dongle, while said output queue being for storing the music signals outputted from said game console end; said RF interface of wireless dongle being the interface for conducting wireless data transmission with multiple wireless gaming devices; and
at least one wireless gaming device, comprising a RF interface of wireless gaming device, a packet processing module, a keyboard unit and an audio output interface; said keyboard unit being an element for users to manipulate various game control;
said packet processing module having a keyboard command packet queue and a music queue therein, in which said keyboard command packet queue is for storing the input data of controlling game by operating said keyboard unit at player end, and said music queue is for storing the music signals came from said game console end; said RF interface of the wireless gaming device being an interface for conducting wireless data transmission with said wireless dongle, by which the data in said keyboard command packet queue is transmitted to said wireless dangle, and by which the music signals of the game console end emitted by the wireless dongle is received; said audio output interface being for outputting the music signals from said music queue to an audio output device where the music signals is then played.

2. The system as claimed in claim 1, wherein said game console end is one of the game host machines constructed from desktop computer, notebook computer, tablet, game machine, set top box, handphone and embedded systems.

3. The system as claimed in claim 1, wherein said game console end interface (host interface) is one of USB, 1394, PCI-e, PS/2, SATA, Ethernet, SPI, and UART.

4. The system as claimed in claim 1, wherein the frequency band used in said RF interface of wireless dongle and said RF interface of wireless gaming device is 2.4 GHz ISM Band.

5. The system as claimed in claim 1, wherein said audio output device is one of speaker and headset.

6. The system as claimed in claim 1, wherein said wireless gaming device is one of gamepad, steering wheel of race car, joystick and 3D joystick (Wii).

7. A control method for multiple manipulating inputs and music outputs of wireless gaming device, having multiple wireless gaming devices at player end and a wireless dongle mounted on a game console; under the same wireless frequency of said wireless dongle and said multiple wireless gaming devices, manipulating signals came from each of said wireless gaming devices being transmitted to said game console and music signals came from said game console being transmitted to each of said wireless gaming devices by said wireless dongle.

8. The control method as claimed in claim 7, wherein the flow process of transmitting manipulating signals came from each of said wireless gaming devices to said game console comprises the steps as below:
(A) set a music period t and a music signals packet is generated in each music period t, and ID value for obtaining desired wireless gaming device is attached to said music signals packet;
(B) ID value of each wireless gaming device is set by said wireless dongle, and the range of the ID value is between 0 and the quantity of the wireless gaming device (m)−1;
(C) When each music period t arrives, said wireless dongle immediately sends music signals packet attached with ID value of desired wireless gaming device regularly to all wireless gaming devices, the period of attaching the ID value, corresponding to each of the wireless gaming devices, to the packet sent by the wireless dongle is T;
(D) All the wireless gaming devices receive the packet sent in step (C), and the wireless gaming device having its ID value conforming to the ID value in the packet makes a reply to said wireless dongle with a game manipulating signals packet;
(E) Once said wireless dongle receives the packet of step (D), a reply to said game console with the game command of the associated device is conducted; next, a new ID value is generated by adding 1 to the ID value and the new ID value is attached to the music signals packet; and steps (C), (D), (E) are repeated so that said wireless dongle outputs manipulating signals to said game console sequentially;
(F) When the HID period to the first wireless gaming device calculated by said wireless dongle arrives, the ID value is automatically set to ground zero and process is returned to step (C).

9. The control method as claimed in claim 8, further comprising a D1 step subsequent to the step (C); in D1 step, whether said wireless dongle has received game manipulating signals packet transmitted from said wireless gaming device or not is further judged during a music period t, and if said wireless dongle hasn't received the game manipulating signals packet transmitted from said wireless gaming device until the end of said music period t, said wireless dongle being enforced to depart from RF reception state and said ID value being enforced to add with 1, and then the process being returned to step (C).
